(19) United States
(12) Patent Application Publication
(10) Pub. No.: US 2007/0143781 A1
(43) Pub. Date: Jun. 21, 2007

(54) METHOD OF PROVIDING DIGITAL BROADCAST AND BROADCAST RECEIVING TERMINAL FOR RECEIVING A DIGITAL BROADCAST

(75) Inventor: Young Sub Jo, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/610,461

(22) Filed: Dec. 13, 2006

(30) Foreign Application Priority Data
Dec. 13, 2005 (KR) 10-2005-0122521

(51) Int. Cl. H04N 7/16

(52) U.S. Cl. 725/25

(57) ABSTRACT

A method of providing a digital broadcast and apparatus for receiving a digital broadcast are disclosed, by which a CA (conditional access) digital broadcast can be temporarily provide to enable a digital broadcast user to easily decide whether to subscribe to a pay broadcasting service by allowing the broadcast user to temporarily access the pay broadcasting service without necessary qualification or condition. The present invention generates a digital broadcast transmission frame for digital broadcast content including time-limited broadcast reception admission information to enable the digital broadcast to be received for a limited time.

### CROSS-REFERENCE TO RELATED APPLICATIONS

Pursuant to 35 U.S.C. §119(a), this application claims the benefit of earlier filing date and right of priority to Korean Application No. No. 10-2005-0122521, filed on Dec. 13, 2005, the contents of which is hereby incorporated by reference herein in its entirety.

### FIELD OF THE INVENTION

The present invention is directed to a digital broadcast system, and more specifically, to a method of providing a digital broadcast and a broadcast receiving terminal for receiving a digital broadcast.

### DESCRIPTION OF THE RELATED ART

Digital audio devices having excellent audio quality, such as CD and DVD devices, have been provided in order to keep up with increasing demands for digital broadcasts having high quality sound. DAB (digital audio broadcasting) has been adopted and serviced by the EU, Canada, the U.S.A. and other countries in order to overcome the limited audio quality provided by conventional FM broadcasts.

The DAB system provides excellent mobile reception capability as well as high quality sound using technology completely different from that of current AM or FM broadcasts. The DAB system is characterized by fast digital data transmissions including videos and characters.

Various multimedia, such as video and broadcasting, is emphasized more with respect to mobile broadcasting services than audio broadcasting in countries such as Korea. Therefore, such multimedia is called digital multimedia broadcasting (DMB).

The U.S.A., the EU and Japan have proposed other mobile broadcasting services that are different than DMB, for example. MediaFLO in the U.S.A., DVB-H (digital video broadcasting-Handheld) in the EU and ISDB-T (integrated service digital broadcasting-terrestrial) in Japan are examples of such mobile broadcasting services.

A function called conditional access (CA) allows only qualified users to view a broadcast service in digital broadcasting. Only a qualified user is able to view a charged, or pay-for-view, service when the CA function is used.

A ‘tour’ menu is provided in order to enable an Internet user to decide whether to use Internet pay broadcast contents after learning about the Internet pay contents. However, an Internet ‘tour’ menu is not provided for a digital pay broadcasting service. Therefore, a digital broadcast user has difficulty deciding whether to subscribe to a pay broadcasting service.

### SUMMARY OF THE INVENTION

An object of the present invention is to provide a method of providing a digital broadcast and a broadcast receiving terminal for receiving a digital broadcast, by which a conditional access (CA) digital broadcast can be temporarily provided to enable a digital broadcast user to easily decide whether to subscribe to a pay broadcasting service. The user is allowed to temporarily access the pay broadcasting service without qualification or condition.

In one aspect of the present invention, a method of providing a digital broadcast service is provided. The method includes generating a digital broadcast transmission frame including digital broadcast content and time-limited broadcast reception admission information, at least a portion of the digital broadcast content subject to conditional access restrictions, and transmitting the digital broadcast transmission frame to at least one user, wherein the time-limited broadcast reception admission information enables the at least one user to have temporary access to the conditional access restricted digital broadcast content.

It is contemplated that generating the time-limited broadcast reception admission information includes at least one of generating time-limited service type information indicating a portion of the conditional access restricted digital broadcast content to which the at least one user has temporary access and generating time-limited broadcast time information indicating a time for which temporary access is granted. It is further contemplated that generating the digital broadcast transmission frame includes including the time-limited broadcast reception admission information in at least one Fast Information Block (FIB) of the digital broadcast transmission frame.

It is contemplated the at least one FIB includes at least one Fast Information Group (FIG), each of the at least one FIG having a header indicating a type and a data field having an extension field and generating the digital broadcast transmission frame further includes including the time-limited broadcast reception admission information in a FIG of type 0 with an extension of 3 or 4. It is further contemplated that generating the digital broadcast transmission frame further includes including the time-limited broadcast reception admission information in a service component conditional access (SCCA) field.

It is contemplated that generating the digital broadcast transmission frame further includes including the time-limited broadcast reception admission information in a portion of the SCCA field that is reserved for future use. It is further contemplated that the SCCA field is a CAOrg field.

It is contemplated that generating the time-limited broadcast reception admission information includes at least one of generating time-limited service type information indicating a portion of the conditional access restricted digital broadcast content to which the at least one user has temporary access and generating time-limited broadcast time information indicating a time for which temporary access is granted. It is further contemplated the SCCA field includes a field indicating a scrambling code and a field reserved for future use and generating the time-limited broadcast reception admission information further includes indicating the time-limited service type information using at least one reserved scrambling code and indicating the time-limited broadcast time information using the field reserved for future use. Preferably, the SCCA field is a CAOrg field, the field indicating a scrambling code is a CAMode field and the field reserved for future use is an rfu field.

In another aspect of the present invention, a terminal adapted to receive a digital broadcast service is provided. The terminal includes a receiving unit adapted to receive a digital broadcast transmission frame including digital broadcast content and time-limited broadcast reception admission information, at least a portion of the digital broadcast content subject to conditional access restrictions, an output unit adapted to output the digital broadcast content and a control unit adapted to extract the time-limited broadcast reception admission information from the digital broadcast transmission frame and control the output unit according to the extracted time-limited broadcast reception admission information such that a user has temporary access to the conditional access restricted digital broadcast content.

It is contemplated that the control unit is further adapted to control the output unit according to at least one of time-limited service type information indicating a portion of the conditional access restricted digital broadcast content to which the user is given temporary access and time-limited broadcast time information indicating a time for which temporary access is granted. It is further contemplated that the control unit is further adapted to extract the time-limited broadcast reception admission information from at least one Fast Information Block (FIB) of the digital broadcast transmission frame.

It is contemplated that the at least one FIB includes at least one Fast Information Group (FIG), each of the at least one FIG having a header indicating a type and a data field having an extension field and the control unit is further adapted to extract the time-limited broadcast reception admission information from a FIG of type 0 with an extension of 3 or 4. It is further contemplated that the control unit is further adapted to extract the time-limited broadcast reception admission information from a service component conditional access (SCCA) field.

It is contemplated that the control unit is further adapted to extract the time-limited broadcast reception admission information from a portion of the SCCA field that is reserved for future use. It is further contemplated that the SCCA field is a CAOrg field.

It is contemplated that the control unit is further adapted to control the output unit according to at least one of time-limited service type information indicating a portion of the conditional access restricted digital broadcast content to which the user is given temporary access and time-limited broadcast time information indicating a time for which temporary access is granted. It is further contemplated that the SCCA field includes a field indicating a scrambling code and a field reserved for future use and the control unit is further adapted to determine the time-limited service type information according to at least one reserved scrambling code and determine the time-limited broadcast time information according to the field reserved for future use. Preferably, the SCCA field is a CAOrg field, the field indicating a scrambling code is a CAMode field and the field reserved for future use is an rfu field.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a DMB transmission frame.

FIG. 2 illustrates a Fast Information Block (FIB).

FIG. 3 illustrates a FIG type 0 field.

FIG. 4 illustrates a service component field in packet mode.

FIG. 5 illustrates a service component field in FIC or stream mode.

FIG. 6 illustrates a format of a CAOrg field.

FIG. 7 is a schematic block diagram of a broadcast receiving terminal according to the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used throughout the drawings to refer to the same or like parts.

A digital broadcast providing method according to the present invention is explained in the following description using a terrestrial DMB service in Korea as an example. It is apparent that the present invention is applicable not only to the digital broadcasting service in Korea but also to MediaFLO in the U.S.A., DVB-H (digital video broadcasting-Handheld) in the EU, ISDB-T (integrated service digital broadcasting-terrestrial) in Japan as well as other similar services.

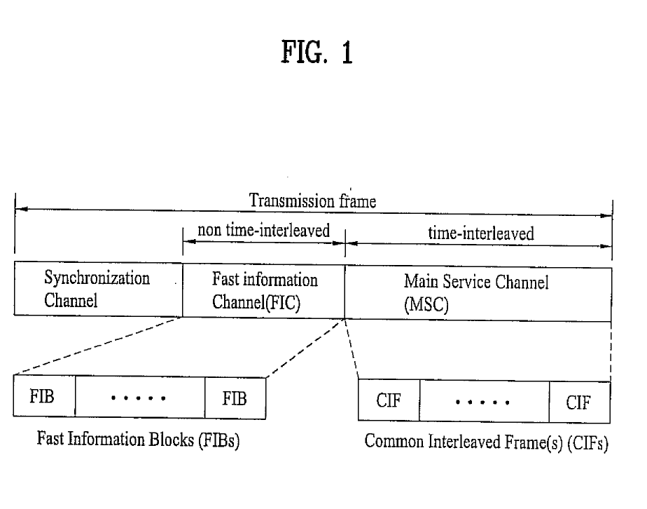

A configuration of a transmission frame for a DMB service defined in ETSI EN 300 401 V1.3.3 (2005-05) and reported as a result of Eureka Project 147 is explained with reference to FIG. 1. FIG. 1 illustrates a DMB transmission frame, which includes a main service channel (MSC), a fast information channel (FIC) and a synchronization channel.

The MSC is used to carry video, audio and data service components. The MSC is a time-interleaved data channel divided into a number of sub-channels, which are individually and convolutionally coded with equal or unequal error protection.

Each sub-channel may carry one or more service components. The organization of the sub-channels and service components is referred to as the multiplex configuration.

The FIC is used to enable a receiver to rapidly access information. Specifically, the FIC is used to send Multiplex Configuration Information (MCI) and, optionally, Service Information and data services together.

The FIC is a non-time-interleaved data channel having fixed equal error protection. The FIC is sub-divided into a plurality of FIBs (Fast Information Blocks).

The Synchronization channel is used internally within the transmission system for basic demodulator functions. Basic demodulator functions include transmission frame synchronization, automatic frequency control, channel state estimation and transmitter identification.

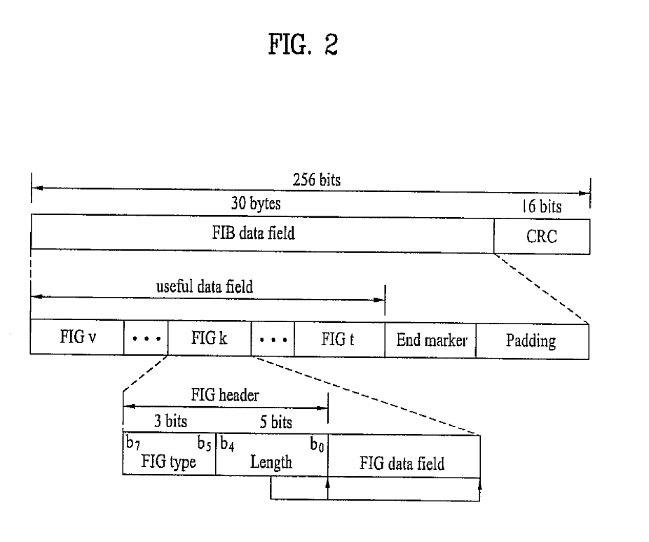

A configuration of an FIB (Fast Information Block) is explained in detail with reference to FIG. 2. FIG. 2 illustrates an FIB.

As illustrated in FIG. 2, an FIB includes an FIB data field and a CRC (cyclic redundancy check). The FIB data field further includes at least one FIG (fast information group), an end marker and padding.

The FIG includes an FIG header and an FIG data field. The FIG header includes an FIG type and a length.

The FIG type indicates the type of data contained in the FIG data field and the length indicates a length of the FIG data field. A list of FIG types is shown in Table 1.

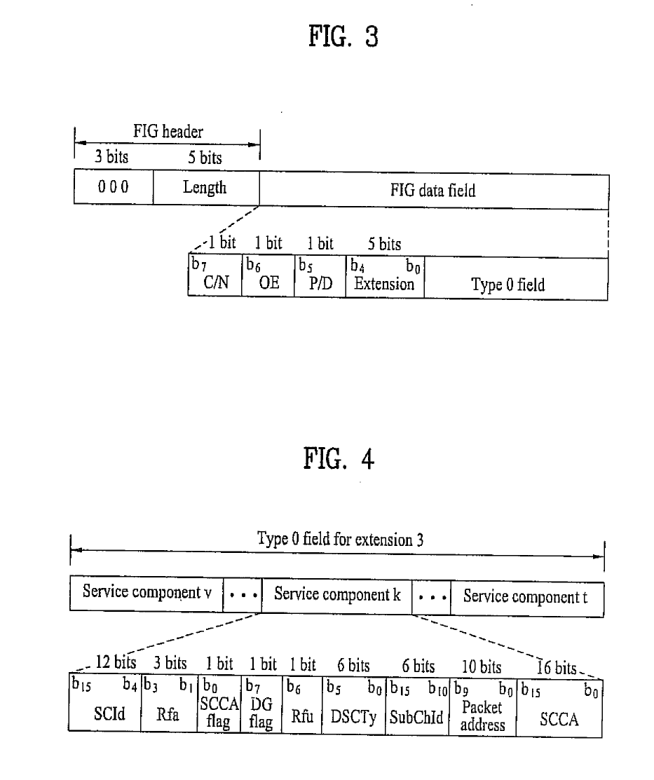

In the present invention, FIG type 0 listed in Table 1 is a major concern of interest. The FIG data field according to FIG type 0 is explained with reference to FIG. 3, which illustrates a FIG type 0 field.

TABLE 1

| FIG type number | FIG type | FIG application |
|---|---|---|
| 0 | 000 | MIC and part of the SI |
| 1 | 001 | Labels, etc. (part of the SI) |
| 2 | 010 | Reserved |
| 3 | 011 | Reserved |
| 4 | 100 | Reserved |
| 5 | 101 | FIC Data Channel |
| 6 | 110 | Conditional Access (CA) |
| 7 | 111 | In house (except for Length 31) |

As illustrated in FIG. 3, FIG type 0 is used to indicate current and future multiplex configuration, multiplex reconfiguration, time and date, and other basic service information. As illustrated in FIG. 3, an extension field and a type 0 field exists in the FIG type 0 data field. The extension field identifies one of 32 interpretations of the FIG type 0 field.

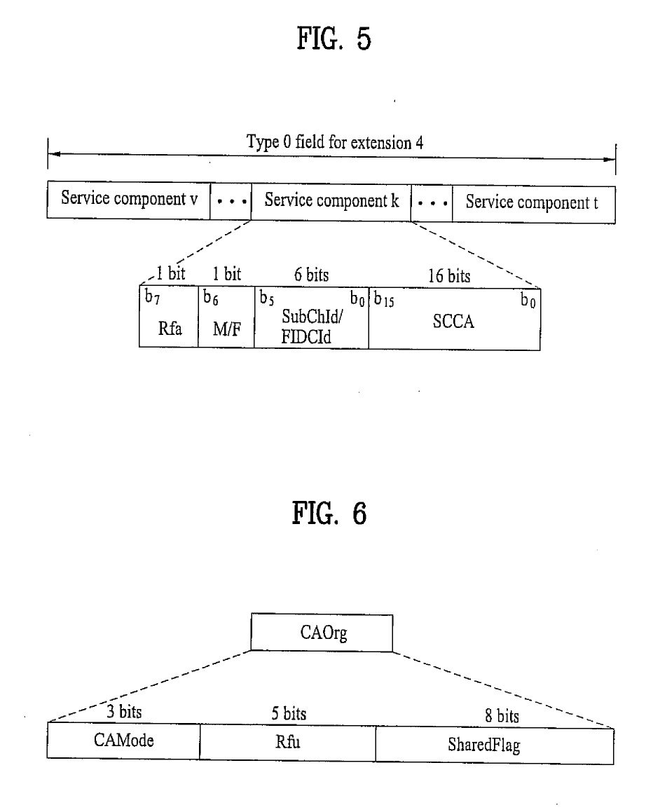

The present invention is directed to Extension 3 and Extension 4 of FIG type 0, which are explained with reference to FIGS. 4 and 5. FIG. 4 illustrates a service component field in packet mode and FIG. 5 illustrates a service component field in FIC or stream mode.

There commonly exists a 16-bit service component conditional access (SCCA) field in a service component field, as illustrated in FIGS. 4 and 5. The SCCA field is assigned for CA, which is defined in detail as CAOrg (CA origination) field in ETSI TS 102 367 V2.1.1 (2006-01).

Time-limited broadcast reception admission information is recorded in the CAOrg field in order to enable reception of a digital broadcast transmitted by the DMB transmission frame for a limited time. The time-limited broadcast reception admission information preferably includes time-limited broadcast service type information and time-limited broadcast time information.

The time-limited broadcast service type information indicates a type of time-limited broadcast service. The time-limited broadcast time information indicates a time-limited broadcast time, or how long the broadcast service may be toured.

However, it is unnecessary to configure the time-limited broadcast reception admission information in this manner. Alternatively, the time-limited broadcast reception admission information may include either time-limited broadcast service type information or time-limited broadcast time information.

A format of recording the time-limited broadcast reception admission information in the CAOrg field is explained in detail with reference to FIG. 6, which illustrates a format of a CAOrg field. As illustrated in FIG. 6, the CAOrg field includes a 3-bit CAMode (CA mode) field, a 5-bit Rfu (reserved for future use) and an 8-bit SharedFlag field. The CAMode field indicates a currently applied scrambling mode and is defined in ETSI TS 367 V2.1.1 (2005-09) as having the format shown in Table 2.

The present invention proposes to record the time-limited broadcast service type information using the reserved code in the CAMode field. Specifically, a ‘100’, ‘101’, ‘110’ or ‘111’ code is utilized as the time-limited broadcast service type information that allows time-limited access to a CA broadcast. In this way, a user is allowed to ‘tour’ CA broadcast contents without having to meet a prescribed qualification.

In one embodiment of the present invention, an agreement can be made in advance between a broadcasting station and a broadcast receiving terminal to enable ‘100’, ‘101’, ‘110’ and ‘111’ codes to allow time-limited tours of broadcast service of, respectively, ‘Subchannel CA’, ‘Data Group CA’, ‘MOT CA’ and ‘proprietary CA’ among various broadcast services. However, the agreement is only exemplary. Alternatively, a ‘time-limited tour’ may be previously agreed in a different manner, such as utilizing the ‘101 ’ code to indicate a time-limited tour of ‘Subchannel CA’ instead of ‘Data Group CA’.

TABLE 2

| | |
|---|---|
| 000 | Subchannel CA |
| 001 | Data Group CA |
| 010 | MOT CA |
| 011 | Proprietary CA |
| 100 | Reserved |
| 101 | Reserved |
| 110 | Reserved |
| 111 | Reserved |

The present invention further proposes to record the time-limited broadcast time information in the Rfu field using 5 bits. For example, it can be previously agreed that ‘0001’, ‘00010’, ‘00011’ indicate, respectively, 5 seconds, 10 seconds, and 15 seconds.

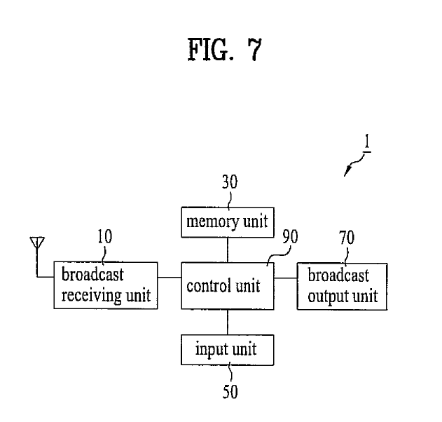

In this way, a terminal user is able to ‘tour’ a CA broadcast for a predetermined time regardless of qualification to view the CA broadcast when selecting a channel of the CA broadcast according to the present invention. A broadcast receiving terminal capable of providing a broadcast service on a time-f limited bases regardless of qualification to receive a CA broadcast by receiving the DMB transmission frame transmitted in the above-explained manner is explained with reference to FIG. 7.

FIG. 7 illustrates a schematic block diagram of a broadcast receiving terminal 1 according to the present invention. As illustrated in FIG. 7, the terminal 1 includes a broadcast receiving unit 10, a memory unit 30, an input unit 50, a broadcast output unit 70 and a control unit 90.

The broadcast receiving unit 10 receives a digital broadcast signal, such as a DMB transmission frame, and performs signal processing on the received signal. The memory unit 30 stores programs necessary for operations and management of the broadcast receiving terminal 1 and various information or data randomly stored according to a user's necessity. The input unit 50 enables a terminal user to input various commands or information to the broadcast receiving terminal 1.

The broadcast output unit 70 outputs a digital broadcast received and signal-processed by the broadcast receiving unit 10 to the terminal user. Preferably, the broadcast output unit 70 includes a video display unit (not shown) and an audio output unit (not shown).

The control unit 90 controls the broadcast receiving unit 10, the memory unit 30, the input unit 50 and the broadcast output unit 70. Specifically, the control unit 90 extracts time-limited broadcast reception admission information from a transmission frame of a digital broadcast provided according to the method of the present invention and controls the digital broadcast such that it is output on a time-limited basis to a terminal user.

The portion of the transmission frame from which the time-limited broadcast reception admission information is extracted has already been explained in the foregoing description of the method according to the present invention. Therefore, a detailed explanation is omitted.

The present invention provides several effects or advantages. A digital broadcast user is allowed to temporarily access a CA pay broadcast service without qualification or condition. In this way, a service provider is able to promote a pay broadcast service subscription to a digital broadcast user and the user is able to temporarily access the pay broadcast service in order to decide whether to subscribe to the pay broadcast service.

Although, a terrestrial DMB is used as an example for the disclosure of the present invention, it will be apparent to those skilled in the art that the present invention is applicable to any digital broadcast capable of implementing the CA broadcasting.

It will be apparent to those skilled in the art that various modifications and variations can be made in the present invention without departing from the spirit or scope of the inventions. Therefore, it is intended that the present invention covers the modifications and variations of this invention provided they come within the scope of the appended claims and their equivalents.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses.

The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method of providing a digital broadcast service, comprising:
generating a digital broadcast transmission frame comprising digital broadcast content and time-limited broadcast reception admission information, at least a portion of the digital broadcast content subject to conditional access restrictions; and
transmitting the digital broadcast transmission frame to at least one user,
wherein the time-limited broadcast reception admission information enables the at least one user to have temporary access to the conditional access restricted digital broadcast content.

2. The method of claim 1, wherein generating the time-limited broadcast reception admission information comprises at least one of:
generating time-limited service type information indicating a portion of the conditional access restricted digital broadcast content to which the at least one user has temporary access; and
generating time-limited broadcast time information indicating a time for which temporary access is granted.

3. The method of claim 1, wherein generating the digital broadcast transmission frame comprises:
including the time-limited broadcast reception admission information in at least one Fast Information Block (FIB) of the digital broadcast transmission frame.

4. The method of claim 3, the at least one FIB comprising at least one Fast Information Group (FIG), each of the at least one FIG having a header indicating a type and a data field having an extension field and wherein generating the digital broadcast transmission frame further comprises:
including the time-limited broadcast reception admission information in a FIG of type 0 with an extension of 3 or 4.

5. The method of claim 4, wherein generating the digital broadcast transmission frame further comprises:
including the time-limited broadcast reception admission information in a service component conditional access (SCCA) field.

6. The method of claim 5, wherein generating the digital broadcast transmission frame further comprises:
including the time-limited broadcast reception admission information in a portion of the SCCA field that is reserved for future use.

7. The method of claim 5, wherein the SCCA field is a CAOrg field.

8. The method of claim 5, wherein generating the time-limited broadcast reception admission information comprises at least one of:
generating time-limited service type information indicating a portion of the conditional access restricted digital broadcast content Lo which the at least one user has temporary access; and
generating time-limited broadcast time information indicating a time for which temporary access is granted.

9. The method of claim 8, the SCCA field comprising a field indicating a scrambling code and a field reserved for future use and wherein generating the time-limited broadcast reception admission information further comprises:
indicating the time-limited service type information using at least one reserved scrambling code; and
indicating the time-limited broadcast time information using the field reserved for future use.

10. The method of claim 9, wherein the SCCA field is a CAOrg field, the field indicating a scrambling code is a CAMode field and the field reserved for future use is an rfu field.

11. A terminal adapted to receive a digital broadcast service, the terminal comprising:
a receiving unit adapted to receive a digital broadcast transmission frame comprising digital broadcast content and time-limited broadcast reception admission information, at least a portion of the digital broadcast content subject to conditional access restrictions;
an output unit adapted to output the digital broadcast content; and
a control unit adapted to extract the time-limited broadcast reception admission information from the digital broadcast transmission frame and control the output unit according to the extracted time-limited broadcast reception admission information such that a user has temporary access to the conditional access restricted digital broadcast content.

12. The terminal of claim 11, wherein the control unit is further adapted to control the output unit according to at least one of:
time-limited service type information indicating a portion of the conditional access restricted digital broadcast content to which the user is given temporary access; and
time-limited broadcast time information indicating a time for which temporary access is granted.

13. The terminal of claim 11, wherein the control unit is further adapted to extract the time-limited broadcast reception admission information from at least one Fast Information Block (FIB) of the digital broadcast transmission frame.

14. The terminal of claim 13, the at least one FIB comprising at least one Fast Information Group (FIG), each of the at least one FIG having a header indicating a type and a data field having an extension field and wherein the control unit is further adapted to extract the time-limited broadcast reception admission information from a FIG of type 0 with an extension of 3 or 4.

15. The terminal of claim 14, wherein the control unit is further adapted to extract the time-limited broadcast reception admission information from a service component conditional access (SCCA) field.

16. The terminal of claim 15, wherein the control unit is further adapted to extract the time-limited broadcast reception admission information from a portion of the SCCA field that is reserved for future use.

17. The terminal of claim 151 wherein the SCCA field is a CAOrg field.

18. The terminal of claim 15, wherein the control unit is further adapted to control the output unit according to at least one of:
time-limited service type information indicating a portion of the conditional access restricted digital broadcast content to which the user is given temporary access; and
time-limited broadcast time information indicating a time for which temporary access is granted.

19. The terminal of claim 18, the SCCA field comprising a field indicating a scrambling code and a field reserved for future use and wherein the control unit is further adapted to:
determine the time-limited service type information according to at least one reserved scrambling code; and
determine the time-limited broadcast time information according to the field reserved for future use.

20. The terminal of claim 19, wherein the SCCA field is a CAOrg field, the field indicating a scrambling code is a CAMode field and the field reserved for future use is and rfu field.
